(19) United States
(12) Patent Application Publication
(10) Pub. No.: US 2013/0098397 A1
(43) Pub. Date: Apr. 25, 2013

(54) SUBSTRATE CLEANING METHOD AND SUBSTRATE CLEANING APPARATUS

(71) Applicant: EBARA CORPORATION, Tokyo (JP)

(72) Inventor: Xinming WANG, Tokyo (JP)

(73) Assignee: EBARA CORPORATION, Tokyo (JP)

(21) Appl. No.: 13/653,674

(22) Filed: Oct. 17, 2012

(30) Foreign Application Priority Data
Oct. 19, 2011 (JP) 2011-229549

(51) Int. Cl. B08B 7/04; B08B 1/04; B08B 3/02

(52) U.S. Cl. 134/6; 15/3

(57) ABSTRACT

The present invention can reduce the burden on a scrub cleaning member without entailing a large footprint and a long cleaning time and can enhance cleaning performance. A moving arm is moved to move a scrub cleaning member from a standby position above the edge of a substrate to a scrub cleaning position above the center of the substrate. A two-fluid nozzle is moved in conjunction with the movement of the moving arm while jetting a mixed fluid from the two-fluid nozzle toward the surface of the rotating substrate to carry out two-fluid jet cleaning of the substrate. After stopping the jetting of the fluid from the two-fluid nozzle, the scrub cleaning member is brought into contact with the surface of the substrate to carry out scrub cleaning of the substrate.

### CROSS REFERENCE TO RELATED APPLICATIONS

This document claims priority to Japanese Patent Application No. 2011-229549, filed on Oct. 19, 2011, the entire contents of which are hereby incorporated by reference.

### BACKGROUND OF THE INVENTION

1. Field of the Invention

The present invention relates to a substrate cleaning method and a substrate cleaning apparatus for a substrate such as a semiconductor wafer, and more particularly to a substrate cleaning method and a substrate cleaning apparatus for use in a substrate cleaning process after polishing such as CMP.

2. Background Art

In a damascene interconnect forming process for forming interconnects in a surface of a substrate by filling a metal into interconnect trenches formed in an insulating film in the surface of the substrate, for example, an extra metal on the surface of the substrate is polished away by chemical mechanical polishing (CMP) after the formation of damascene interconnects. A slurry (residual, slurry), remaining after its use in CMP, metal polishing debris, etc. are present on the surface of the substrate after CMP. Therefore, such residues (particles), remaining on the surface of the substrate after CMP, need to be cleaned off.

As a cleaning method for cleaning a surface of a substrate after CMP, scrub cleaning is known which comprises scrubbing the surface of the substrate with a long cylindrical roll cleaning member (roll sponge or roll brush) by rotating the substrate and the roll cleaning member while keeping the roll cleaning member in contact with the surface of the substrate in the presence of a cleaning liquid (see patent document 1).

A method is known in which prior to scrub cleaning of a surface of a substrate with a roll cleaning member, the surface of the substrate is subjected to megasonic cleaning in the same cleaning tank. The megasonic cleaning is performed by applying ultrasonic waves having a frequency of about 1 MHz to a cleaning liquid, and causing a force of the molecules of the cleaning liquid, produced by vibration acceleration, to act on particles adhering to the surface of the substrate to remove the particles from the substrate.

Two-fluid jet (2FJ) cleaning is known as a cleaning method for cleaning a surface of a substrate in a non-contact manner (see patent document 2). This cleaning method involves jetting a high-speed gas containing fine liquid droplets (mist) from a two-fluid nozzle toward the surface of the substrate and causing the fine liquid droplets to collide against the surface of the substrate. The cleaning method utilizes a shock wave, generated by the collision of fine liquid droplets against the surface of the substrate, to remove (clean off) particles, etc. from the substrate.

The applicant has proposed a substrate cleaning method with high cleaning performance which comprises carrying out scrub cleaning of a surface of a substrate, e.g., after CMP, with a roll cleaning member, and subsequently carrying out two-fluid jet cleaning of the surface of the substrate (see patent document 3).

### PRIOR ART DOCUMENTS

Patent document 1: Japanese Patent Laid-Open Publication No. H10-308374
Patent document 2: Japanese Patent No. 3504023
Patent document 3: Japanese Patent Laid-Open Publication No. 2010-238850

### SUMMARY OF THE INVENTION

A large amount of particles (defects) generally remain on a surface of a substrate after polishing such as CMP. When cleaning such a substrate by scrub cleaning using a scrub cleaning member, such as a roll cleaning member, a heavy burden will be imposed on the scrub cleaning member. This may lead to a short lifetime of the scrub cleaning member and, in addition, may result in insufficient cleaning of a substrate, which will impose a considerable burden on a subsequent cleaning step(s). When it is intended to carry out two-fluid jet cleaning of a substrate after polishing prior to and independently of scrub cleaning of the substrate, it is necessary to provide a scrub cleaning unit and a two-fluid jet cleaning unit separately, and to transport a substrate, which has undergone two-fluid jet cleaning in the two-fluid jet cleaning unit, to the scrub cleaning unit to carry out scrub cleaning of the substrate. A large footprint and a long cleaning time will therefore be needed.

On the other hand, when non-contact megasonic cleaning of a substrate is carried out prior to scrub cleaning of the substrate using a scrub cleaning member, such as a roll cleaning member, in the same processing tank, there are cases where the distance from the jet orifice of a jet nozzle for jetting a cleaning liquid to various portions of a surface of the substrate varies considerably, and therefore the amplitudes of vibration of molecules of the cleaning liquid cannot be equalized. This will result in a failure to achieve good cleaning effect.

The present invention has been made in view of the above situation. It is therefore an object of the present invention to provide a substrate cleaning method and a substrate cleaning apparatus which can reduce the burden on a scrub cleaning member without entailing a large footprint and a long cleaning time and can perform cleaning of a surface of a substrate after polishing with enhanced cleaning performance.

In order to achieve the object, the present invention provides a substrate cleaning method comprising carrying out two-fluid jet cleaning of a surface of a substrate after polishing by jetting a mixed fluid, consisting of two or more types of fluids, from a two-fluid nozzle toward the surface of the substrate to clean the substrate in a non-contact manner, immediately before carrying out scrub cleaning of the substrate by rubbing a scrub cleaning member against the surface of the substrate.

By thus carrying out non-contact two-fluid jet cleaning of a surface of a substrate after polishing immediately before carrying out scrub cleaning of the surface of the substrate, particles such as polishing debris, remaining on the surface of the substrate after polishing, can be partly removed from the substrate. This can reduce the burden on a scrub cleaning member to be used in the subsequent scrub cleaning and enhance the cleaning performance, such as the particle removal performance, cleaning stability, the lifetime of the consumable, etc.

In a preferred aspect of the present invention, a moving arm is moved to move a scrub cleaning member from a standby position above the edge of the substrate to a scrub cleaning position above the center of the substrate; the two-fluid nozzle is moved in conjunction with the movement of the moving arm while jetting the fluid from the two-fluid nozzle toward the surface of the rotating substrate to carry out two-fluid jet cleaning of the substrate; and after stopping the jetting of the fluid from the two-fluid nozzle, the scrub cleaning member is brought into contact with the surface of the substrate to carry out scrub cleaning of the substrate.

Thus, the scrub cleaning member is moved from a standby position above the edge of the substrate to a scrub cleaning position above the center of the substrate while carrying out two-fluid jet cleaning of the surface of the substrate, and subsequently scrub cleaning of the surface of the substrate is carried out. This makes it possible to successively carry out two-fluid jet cleaning and the immediately-following scrub cleaning of the surface of the substrate without a significant increase in the cleaning time and to enhance the cleaning performance.

In a preferred aspect of the present invention, the movement speed of the moving arm is changed during the two-fluid jet cleaning.

For example, the movement speed of the moving arm may be changed according to the radius of a substrate to be cleaned after polishing, so that cleaning of the substrate can be performed uniformly over an entire surface of the substrate.

In a preferred aspect of the present invention, the travel distance of the two-fluid nozzle that moves while jetting the fluid is shorter than the radius of the substrate.

Particles (defects) such as polishing debris are likely to remain in the peripheral portion of a surface of a substrate after polishing. When the travel distance of the two-fluid nozzle that moves while jetting the fluid is made shorter than the radius of the substrate, the peripheral portion (e.g., a 50-mm annular area including the edge) of a substrate can be cleaned intensively. This enables efficient cleaning of the surface of the substrate in an allowable time (e.g., 5 seconds) for two-fluid jet cleaning.

In a preferred aspect of the present invention, while carrying out two-fluid jet cleaning of the surface of the substrate by jetting the fluid from the two-fluid nozzle, disposed above one edge position on the substrate, toward the surface of the rotating substrate, the scrub cleaning member is moved from a standby position above another edge position on the substrate to a scrub cleaning position above the center of the substrate; and after stopping the jetting of the fluid from the two-fluid nozzle, the scrub cleaning member is brought into contact with the surface of the substrate to carry out scrub cleaning of the substrate.

Also in this aspect, the scrub cleaning member is moved from a standby position above the edge of the substrate to a scrub cleaning position above the center of the substrate while carrying out two-fluid jet cleaning of the surface of the substrate, and subsequently scrub cleaning of the surface of the substrate is carried out. This makes it possible to successively carry out two-fluid jet cleaning and the immediate scrub cleaning of the surface of the substrate without a significant increase in the cleaning time and to enhance the cleaning performance.

The two-fluid nozzle may be a sector nozzle having a sector-shaped jet orifice.

The use of a sector nozzle, having a sector-shaped jet orifice, as the fixed two-fluid nozzle can ensure a sufficient cleaning length to perform two-fluid jet cleaning of the entire surface of the substrate.

The present invention also provides a substrate cleaning apparatus comprising: a substrate holder for holding and rotating a substrate; a scrub cleaning member for rubbing it against a surface of the rotating substrate, held by the substrate holder, to carry out scrub cleaning of the substrate; a two-fluid nozzle for jetting a mixed fluid, consisting of two or more types of fluids, toward the surface of the rotating substrate, held by the substrate holder, to carry out non-contact two-fluid jet cleaning of the substrate; a moving arm for simultaneously moving the scrub cleaning member and the two-fluid nozzle; and an arm movement mechanism for moving the moving arm so that the scrub cleaning member moves between a standby position above the edge of the substrate held by the substrate holder and a scrub cleaning position above the center of the substrate.

Two-fluid jet cleaning and scrub cleaning of a substrate can be performed by the single cleaning apparatus having a relatively simple construction without the need for the provision of a cleaning unit exclusively for two-fluid jet cleaning. The substrate cleaning apparatus of the present invention thus enables a significant reduction of the footprint.

In a preferred aspect of the present invention, the two-fluid nozzle is mounted to the moving arm via a nozzle movement mechanism so that the two-fluid nozzle can move between a fluid jetting position where the two-fluid nozzle jets the fluid toward the surface of the rotating substrate and a standby position where the two-fluid nozzle does not interfere with contact of the scrub cleaning member with the surface of the substrate.

This can make the distance between a surface of a substrate and the two-fluid nozzle optimal for two-fluid jet cleaning and, in addition, can prevent the two-fluid nozzle from interfering with scrub cleaning of the surface of the substrate with the scrub cleaning member.

Preferably, the arm movement mechanism can change the movement speed of the moving arm.

The present invention also provides a substrate cleaning apparatus comprising: a substrate holder for holding and rotating a substrate; a scrub cleaning member for rubbing it against a surface of the rotating substrate, held by the substrate holder, to carry out scrub cleaning of the substrate; a two-fluid nozzle, installed above one edge position on the substrate held by the substrate holder, for jetting a mixed fluid, consisting of two or more types of fluids, toward the surface of the rotating substrate, held by the substrate holder, to carry out non-contact two-fluid jet cleaning of the substrate; a moving arm for moving the scrub cleaning member; and an arm movement mechanism for moving the moving arm so that the scrub cleaning member moves between a standby position above another edge position on the substrate held by the substrate holder and a scrub cleaning position above the center of the substrate.

Two-fluid jet cleaning and scrub cleaning of a substrate can be performed by the single cleaning apparatus having a relatively simple construction without the need for the provision of a cleaning unit exclusively for two-fluid jet cleaning. The substrate cleaning apparatus of the present invention thus enables a significant reduction of the footprint. Further, this cleaning apparatus can have a further simplified construction.

The two-fluid nozzle may be a sector nozzle having a sector-shaped jet orifice.

According to the present invention, by carrying out non-contact two-fluid jet cleaning of a substrate after polishing immediately before carrying out scrub cleaning of the substrate, the number of particles (defects) such as polishing debris, remaining on s surface of the substrate after polishing, can be reduced, e.g., to ⅕ to 1/30. This can reduce the burden on a scrub cleaning member to be used in the subsequent scrub cleaning and enhance the cleaning performance, such as the particle removal performance, cleaning stability, the lifetime of the consumable, etc.

Further, the scrub cleaning member is moved from a standby position above the edge of the substrate to a scrub cleaning position above the center of the substrate while carrying out two-fluid jet cleaning of the substrate, and subsequently scrub cleaning of the substrate is carried out. This makes it possible to successively carry out two-fluid jet cleaning and the immediately-following scrub cleaning of the substrate without a significant increase in the cleaning time and to enhance the cleaning performance.

### BRIEF DESCRIPTION OF THE DRAWINGS

FIG. 1 is a plan view showing the overall construction of a polishing apparatus provided with a substrate cleaning apparatus (first substrate cleaning unit) according to an embodiment of the present invention;

FIG. 2 is a schematic front view of the substrate cleaning apparatus according to the present invention, illustrating the apparatus when it is performing two-fluid jet cleaning while moving a scrub cleaning member;

FIG. 3 is a schematic front view of the substrate cleaning apparatus according to the present invention, illustrating the apparatus when it is performing scrub cleaning with a scrub cleaning member in a scrub cleaning position;

FIG. 4 is a flow chart showing a cleaning process for cleaning a substrate after polishing by the substrate cleaning units of the polishing apparatus shown in FIG. 1; and

FIG. 5 is a schematic front view of a substrate cleaning apparatus according to another embodiment of the present invention.

### DETAILED DESCRIPTION OF THE PREFERRED EMBODIMENTS

Embodiments of the present invention will be described below with reference to the drawings. Identical or corresponding elements are denoted by identical reference numerals and repetitive descriptions thereof are omitted.

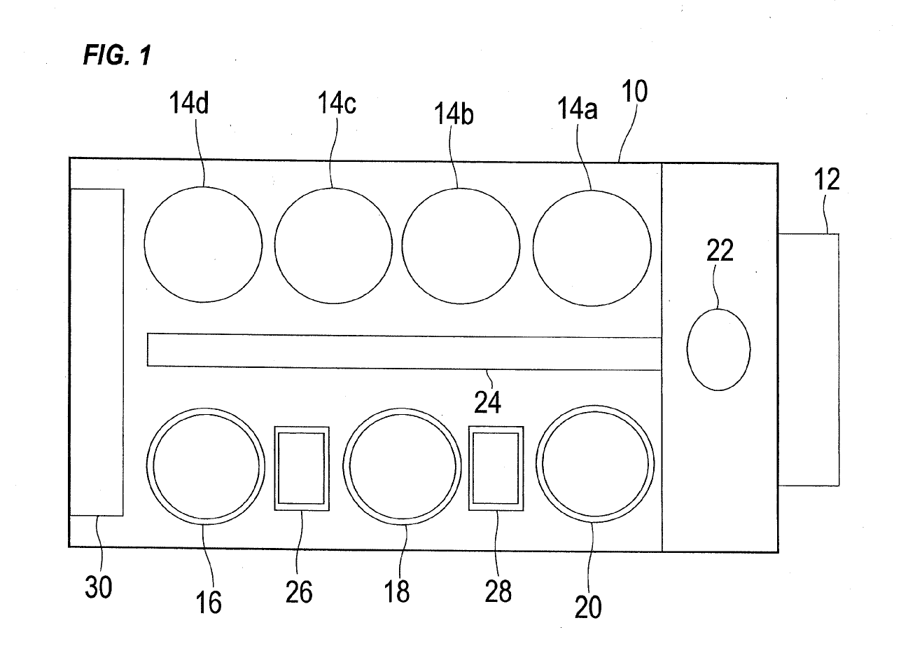

FIG. 1 is a plan view showing the overall construction of a polishing apparatus incorporating a substrate cleaning apparatus according to an embodiment of the present invention. As shown in FIG. 1, this polishing apparatus includes a generally-rectangular housing 10, and a loading port 12 for placing thereon a substrate cassette for storing a large number of substrates, such as semiconductor wafers. The loading port 12 is disposed adjacent to the housing 10 and can be mounted with an open cassette, a SMIF (standard manufacturing interface) or a FOUP (front opening unified pod). A SMIF and a FOUP are each an airtight container which houses therein a substrate cassette and which, by covering it with a partition wall, can keep the internal environment independent of the external environment.

In the housing 10 are housed a plurality of (e.g., four in this embodiment) polishing units 14a-14d, a first substrate cleaning unit 16 and a second substrate cleaning unit 18 each for cleaning a substrate after polishing, and a drying unit 20 for drying a substrate after cleaning. The polishing units 14a-14d are arranged in the longitudinal direction of the polishing apparatus, and the substrate cleaning units 16, 18 and the drying unit 20 are also arranged in the longitudinal direction of the polishing apparatus. The first substrate cleaning unit 16 is a substrate cleaning apparatus according to the present invention.

A first substrate transfer robot 22 is disposed in an area surrounded by the loading port 12, the polishing unit 14a located near the loading port 12, and the drying unit 20. Further, a substrate transport unit 24 is disposed parallel to the polishing units 14a-14d. The first substrate transfer robot 22 receives a substrate before polishing from the loading port 12 and transfers the substrate to the substrate transport unit 24, and receives a substrate after drying from the drying unit 20 and returns the substrate to the loading port 12. The substrate transport unit 24 transports a substrate after receiving it from the first substrate transfer robot 22, and transfers the substrate between it and one of the polishing units 14a-14d.

Between the first cleaning unit 16 and the second cleaning unit 18 is disposed a second substrate transfer robot 26 for transferring a substrate between it and the cleaning units 16, 18. Further, between the second cleaning unit 18 and the drying unit 20 is disposed a third substrate transfer robot 28 for transferring a substrate between it and the units 18, 20.

In the housing 10 is also disposed a control section 30 for controlling the operations of the devices of the polishing apparatus. For example, as described below, the control section 30 controls the movement of arm movement mechanisms 44, 54 which move moving arms 48, 58 of the first substrate cleaning unit 16, and a nozzle movement mechanism 66 which move a two-fluid nozzle 70.

In this embodiment, the second substrate cleaning unit 18 is a pencil scrub cleaning unit which performs scrub cleaning of a substrate of a substrate by rubbing a lower end of a vertically-extending pencil-type cleaning tool against the surface of the substrate. The second substrate cleaning unit (pencil scrub cleaning unit) 18 is configured to also perform two-fluid jet (2FJ) cleaning to clean the surface of the substrate in a non-contact manner using a two-fluid jet flow. The drying unit 20 is a spin-rinse-dry (SRD) unit which holds and rotates a substrate at a high speed while rinsing the substrate with pure water, thereby drying the substrate by centrifugal force. It is also possible to use a cleaning section having a two-stage structure, each stage consisting of the substrate cleaning units 16, 18 and the drying unit 20.

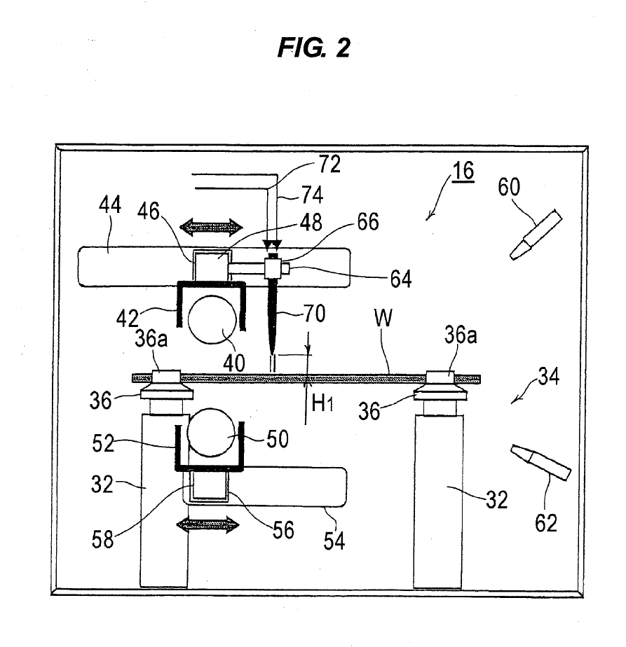

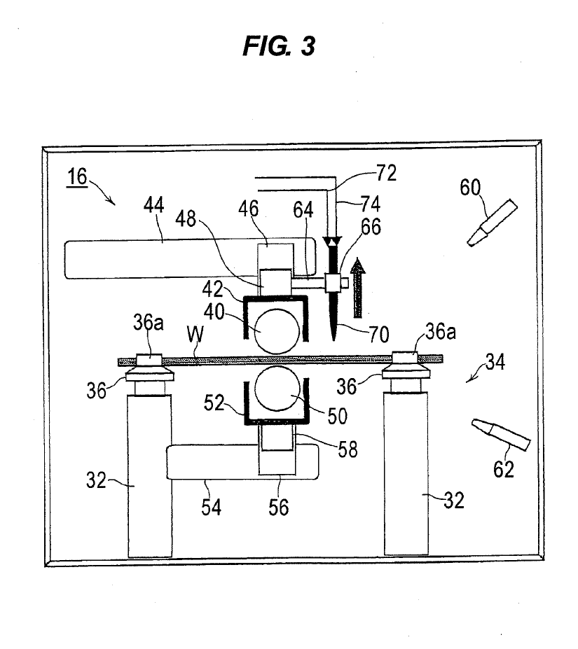

FIG. 2 is a schematic front view of the substrate cleaning apparatus according to the present invention, which is used as the first substrate cleaning unit 16 shown in FIG. 1, illustrating the apparatus when it is performing two-fluid jet cleaning while moving a scrub cleaning member (upper roll cleaning member 40); and FIG. 3 is a schematic front view of the substrate cleaning apparatus (first substrate cleaning unit 16), illustrating the apparatus when it is performing scrub cleaning with the scrub cleaning member in a scrub cleaning position.

As shown in FIGS. 2 and 3, the first substrate cleaning unit (substrate cleaning apparatus) 16 includes a substrate holder 34 having a plurality of (e.g., four as illustrated) horizontally movable spindles 32 for supporting the periphery of a substrate W, such as a semiconductor wafer, with its front surface facing upwardly, and horizontally rotating the substrate W. Each spindle 32, at its top, has a spinning top 36. The peripheral end surface of the substrate W is brought into contact with the contact surface 36a formed in the peripheral surface of each spinning top 36. By spinning the spinning tops 36 while pressing them inwardly against the peripheral end surface of the substrate W, the substrate W is rotated horizontally. In this embodiment, two of the four spinning tops 36 apply a rotational force to the substrate W, while the other two spinning tops 36 each function as a bearing and receive the rotation of the substrate W. It is, however, possible to couple all the spinning tops 36 to a drive mechanism so that they all apply a rotational force to the substrate W.

A long cylindrical upper roll cleaning member 40, e.g., made of PVA, as a scrub cleaning member is disposed above the substrate W held by the spindles 32 of the substrate holder 34. The upper roll cleaning member 40 is rotatably supported by an upper holder 42 which surrounds the upper side of the upper roll cleaning member 40. The upper holder 42 is mounted to the moving arm 48 which is horizontally movable by the arm movement mechanism 44 between a standby position above the edge of the substrate W and a scrub cleaning position above the center of the substrate W, and which is vertically movable by an arm lifting mechanism 46.

Similarly, a long cylindrical lower roll cleaning member 50, e.g., made of PVA, as a scrub cleaning member is disposed below the substrate W held by the spindles 32 of the substrate holder 34. The lower roll cleaning member 50 is rotatably supported by a lower holder 52 which surrounds the lower side of the lower roll cleaning member 50. The lower holder 52 is mounted to a moving arm 58 which is horizontally movable by the arm movement mechanism 54 between a standby position below the edge of the substrate W and a scrub cleaning position below the center of the substrate W, and which is vertically movable by an arm lifting mechanism 56.

In this embodiment, the roll cleaning members (roll sponges), e.g., made of PVA are used as the scrub cleaning members. Instead of the roll cleaning members, it is possible to use roll brushes, which have brushes on surfaces, as scrub cleaning members.

An upper cleaning liquid supply nozzle 60 for supplying a cleaning liquid to the front surface (upper surface) of the substrate W is disposed above the substrate W supported by the spindles 32, while a lower cleaning liquid supply nozzle 62 for supplying a cleaning liquid to the back surface (lower surface) of the substrate W is disposed below the substrate W supported by the spindles 32.

Thus, while horizontally rotating the substrate W and supplying a cleaning liquid (liquid chemical) from the upper cleaning liquid supply nozzle 60 to the front surface (upper surface) of the substrate W, the upper roll cleaning member (scrub cleaning member) 40 in the scrub cleaning position is rotated and lowered to bring it into contact with the front surface of the rotating substrate W, thereby scrub-cleaning the front surface of the substrate W with the upper roll cleaning member 40 in the presence of the cleaning liquid. The length of the upper roll cleaning member 40 is set slightly longer than the diameter of the substrate W, so that the entire surface of the substrate W can be cleaned simultaneously.

Simultaneously with the scrub cleaning of the front surface of the substrate W, scrub cleaning of the back surface of the substrate W is carried out in the following manner: While horizontally rotating the substrate W and supplying a cleaning liquid (liquid chemical) from the lower cleaning liquid supply nozzle 62 to the back surface (lower surface) of the substrate W, the lower roll cleaning member (scrub cleaning member) 50 in the scrub cleaning position is rotated and raised to bring it into contact with the back surface of the rotating substrate W, thereby scrub-cleaning the back surface of the substrate W with the lower roll cleaning member 50 in the presence of the cleaning liquid. The length of the lower roll cleaning member 50 is also set slightly longer than the diameter of the substrate W. Thus, as with the front surface of the substrate W, the entire back surface of the substrate W can be cleaned simultaneously.

A bracket 64, projecting toward the scrub cleaning position, is secured to the moving arm 48 for moving the upper roll cleaning member 40. A downward-facing two-fluid nozzle 70 is mounted via a nozzle movement mechanism 66 to the free end of the bracket 64. In this embodiment, the nozzle movement mechanism 66 is configured to vertically move the two-fluid nozzle 70 between a lower fluid jetting position and an upper standby position. However, it is possible to use a nozzle movement mechanism which is configured to raise the lower end of the two-fluid nozzle 70 by rotating the two-fluid nozzle 70 from its vertical position to its horizontal position.

To the two-fluid nozzle 70 is connected a carrier gas supply line 72 for supplying a carrier gas, such as N₂ gas, and a cleaning liquid supply line 74 for supplying a cleaning liquid, such as pure water, or water containing dissolved CO₂ gas. A two-fluid jet flow of the carrier gas, containing fine liquid droplets (mist) of the cleaning liquid, is created by jetting a mixture of the carrier gas, such as N₂ gas, and the cleaning liquid, such as pure water, or water containing dissolved CO₂ gas, supplied into the two-fluid nozzle 70, at a high speed from the two-fluid nozzle 70. By causing the two-fluid jet flow, created by the two-fluid nozzle 70, to collide against a surface of a rotating substrate. W, particles, etc. can be removed from the surface of the vertically by utilizing a shock wave generated by the collision of the fine liquid droplets against the surface of the vertically. The surface of the vertically can thus be cleaned by the use of the two-fluid jet flow. Though not shown diagrammatically, the two-fluid nozzle may be provided also below a substrate W to clean the back surface of the substrate W.

According to the substrate cleaning unit (substrate cleaning apparatus) 16 of this embodiment, two-fluid jet cleaning and scrub cleaning of a substrate can be performed by the single cleaning unit having a relatively simple construction without the need for the provision of a cleaning unit exclusively for two-fluid jet cleaning. The substrate cleaning unit 16 thus enables a significant reduction of the footprint.

An operational flow in cleaning of a substrate after polishing, performed by the first substrate cleaning unit 16, will now be described.

First, a substrate W after polishing is held with its front surface facing upwardly by the spindles 32 of the substrate holder 34. At this time, the upper roll cleaning member 40 lies at the standby position above the edge of the substrate W, while the two-fluid nozzle 70 lies at the lower fluid jetting position. While rotating the substrate W horizontally, the arm movement mechanism 44 is actuated to move the moving arm 48 at a predetermined speed so that the upper roll cleaning member 40 in the standby position moves toward the scrub cleaning position. The movement speed of the moving arm 48 is, for example, 30 mm/s. As the moving arm 48 moves, the two-fluid nozzle 70 also moves together with the upper roll cleaning member 40.

Simultaneously with the start of movement of the two-fluid nozzle 70, the carrier gas, such as N₂ gas, and the cleaning liquid, such as pure water, or water containing dissolved CO₂ gas, supplied into the two-fluid nozzle 70, begin to be jetted from the two-fluid nozzle 70 toward the front surface of the rotating substrate W to clean the surface of the substrate W with the two-fluid jet flow. During the two-fluid jet cleaning, the distance H₁ between the substrate W and the lower end of the two-fluid nozzle 70 is, for example, 8 mm; and the upper roll cleaning member 40 is kept apart from the surface of the substrate W.

The jetting of the mixed fluid from the two-fluid nozzle 70 is stopped when the two-fluid nozzle 70 reaches a predetermined position, e.g., a position above the center of the substrate W. The moving arm 48 continues moving to move the upper roll cleaning member 40 at a faster speed to the scrub cleaning position above the center of the substrate W. Next, the two-fluid nozzle 70 is raised from the fluid jetting position to the standby position by the nozzle movement mechanism 66.

Next, the upper roll cleaning member 40 is rotated and lowered to bring it into contact with the front surface of the rotating substrate W and, at the same time, a cleaning liquid is supplied from the upper cleaning liquid supply nozzle 60 to the front surface of the substrate W, thereby scrub-cleaning the front surface of the substrate W with the upper roll cleaning member 40.

After carrying out the scrub cleaning of the front surface of the substrate W for a predetermined time, the upper roll cleaning member 40 is raised, and the supply of the cleaning liquid from the upper cleaning liquid supply nozzle 60 to the surface of the substrate W is stopped. The two-fluid nozzle 70 is then lowered to return it from the standby position to the fluid jetting position. Next, the arm movement mechanism 54 is reversely operated to return the upper roll cleaning member 40, together with the two-fluid nozzle 70, to the standby position. When thus returning the upper roll cleaning member 40 to the standby position, the mixed fluid may be jetted from the two-fluid nozzle 70 toward the front surface of the rotating substrate W to perform two-fluid jet cleaning of the substrate.

In synchronization with the upper roll cleaning member 40, the lower roll cleaning member 50 is moved to the scrub cleaning position below the center of the substrate W. The lower roll cleaning member 50 is then rotated and raised to bring it into contact with the back surface of the rotating substrate W and, at the same time, a cleaning liquid is supplied from the lower cleaning liquid supply nozzle 62 to the back surface of the substrate W, thereby scrub-cleaning the back surface of the substrate W with the lower roll cleaning member 50. After carrying out the scrub cleaning of the back surface of the substrate W for a predetermined time, the lower roll cleaning member 50 is lowered, and the supply of the cleaning liquid from the lower cleaning liquid supply nozzle 62 to the back surface of the substrate W is stopped. The lower roll cleaning member 50 is then returned to the standby position.

After scrub cleaning of the front and back surfaces of the substrate W is completed and the upper and lower roll cleaning members 40, 50 are returned to the respective standby positions, the rotation of the substrate W is stopped and the substrate W is released from the holding by the substrate holder 34. The substrate W after cleaning is transported to the next process.

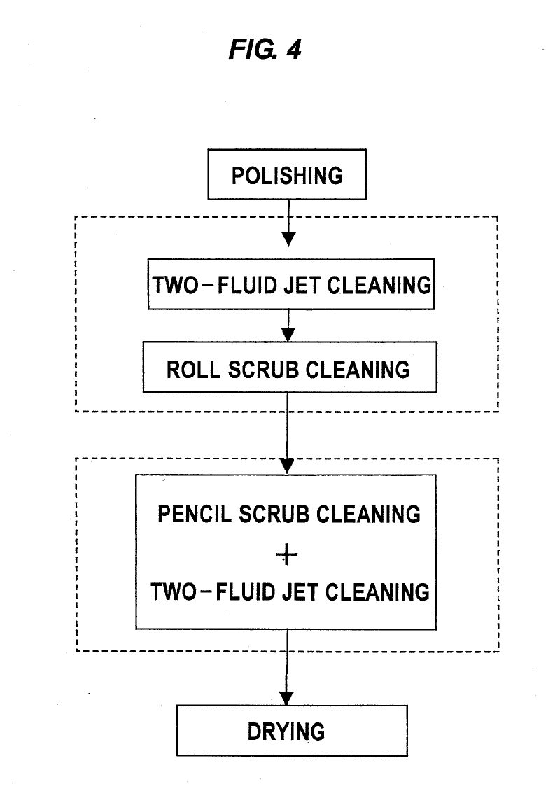

In the polishing apparatus shown in FIG. 1, a substrate is taken out of a substrate cassette in the loading port 12 and transferred to one of the polishing units 14a-14d, where the surface of the substrate is polished, and the substrate after polishing is transferred to the first substrate cleaning unit 16. A cleaning process for a substrate after polishing, as carried out, in the polishing apparatus, will now be described with reference to FIG. 4.

In the first substrate cleaning unit 16, a front surface of a substrate W, which has been polished in one of the polishing units 14a-14d, is cleaned by non-contact two-fluid jet cleaning in the above-described manner. Immediately after the two-fluid jet cleaning, the surface of the substrate is further cleaned by roll scrub cleaning using the upper roll cleaning member 40 in the above-described manner. The back surface of the substrate W is cleaned only by roll scrub cleaning.

By thus carrying out non-contact two-fluid jet cleaning of the surface of the substrate W immediately before carrying out scrub cleaning of the surface of the substrate, particles such as polishing debris, remaining on the surface of the substrate W after polishing, can be partly removed from the surface of the substrate W. This can reduce the burden on a scrub cleaning member (roll cleaning member 40) to be used in the subsequent scrub cleaning and enhance the cleaning performance, such as the particle removal performance, cleaning stability, the lifetime of the consumable, etc.

Particularly in this embodiment, the scrub cleaning member (roll cleaning member 40) is moved from the standby position above the edge of the substrate W to the scrub cleaning position above the center of the substrate W while carrying out two-fluid jet cleaning of the surface of the substrate W, and subsequently scrub cleaning of the surface of the substrate W is carried out. This makes it possible to successively carry out two-fluid jet cleaning and the immediately-following scrub cleaning of the surface of the substrate W without a significant increase in the cleaning time and to enhance the cleaning performance.

The substrate W after the roll scrub cleaning is taken out of the first substrate cleaning unit 16 and transferred to the second substrate cleaning unit 18. In this embodiment, the substrate W is cleaned in the second substrate cleaning unit 18 by a combination of pencil scrub cleaning, which involves rubbing a pencil-type cleaning tool against the surface of the substrate W, and two-fluid jet cleaning using a two-fluid jet flow. It is also possible to carry out only one of pencil scrub cleaning and two-fluid jet cleaning.

The substrate W after cleaning is taken out of the second substrate cleaning unit 18 and carried into the drying unit 20, where the substrate W is dried by an SRD (spin-rinse-dry) process. The substrate W after drying is returned into the substrate cassette in the loading port 12.

The movement speed of the moving arm 48 may be changed during two-fluid jet cleaning. For example, the movement speed of the moving arm 48 may be changed according to the radius of a substrate to be cleaned after polishing, so that cleaning of the substrate can be performed uniformly over an entire surface of the substrate.

Particles (defects), such as polishing debris, are likely to remain in the peripheral portion of a surface of a substrate after polishing. It is therefore preferred that the travel distance of the moving arm 48 during two-fluid jet cleaning is made shorter than the radius of a substrate so that the peripheral portion (e.g., a 50-mm annular area including the edge) of the substrate can be cleaned intensively. This enables efficient cleaning of the surface of the substrate in an allowable time (e.g., 5 seconds) for two-fluid jet cleaning.

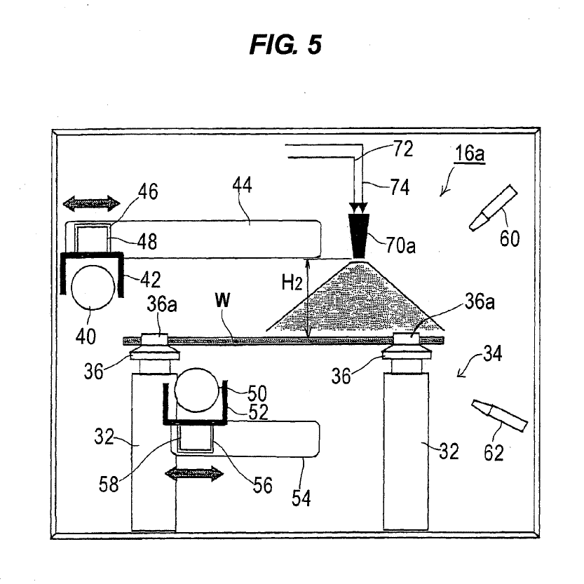

FIG. 5 shows a substrate cleaning unit (substrate cleaning apparatus) 16a according to another embodiment of the present invention. This embodiment differs from the embodiment shown in FIGS. 2 and 3 in the following respects: A downward-facing two-fluid nozzle 70a is disposed above one edge position on a substrate W held by the spindles 32 of the substrate holder 34. The moving arm 48 is not provided with a two-fluid nozzle. The upper roll cleaning member 40 in a standby position lies above another edge position, e.g., opposite the one edge position, on the substrate W held by the spindles 32 of the substrate holder 34.

In this embodiment, the distance H₂ between the substrate W, held by the spindles 32 of the substrate holder 34, and the two-fluid nozzle 70a is set, e.g., at 20 mm. The two-fluid nozzle 70a is a sector nozzle having a sector-shaped jet orifice. The use of such a sector nozzle as the fixed two-fluid nozzle 70a and the appropriate setting of the distance H₂ between the substrate W and the two-fluid nozzle 70a, can ensure a sufficient cleaning length to perform two-fluid jet cleaning of the entire surface of the substrate W.

Also according to the substrate cleaning unit 16a of this embodiment, two-fluid jet cleaning and scrub cleaning of a substrate can be performed by the single cleaning unit having a relatively simple construction without the need for the provision of a cleaning unit exclusively for two-fluid jet cleaning. The substrate cleaning unit 16a thus enables a significant reduction of the footprint. Further, the substrate cleaning unit 16a of this embodiment can have a further simplified construction compared to the embodiment shown in FIGS. 2 and 3.

An operational flow in cleaning of a substrate after polishing, performed by the first substrate cleaning unit 16a, will now be described.

First, a substrate W after polishing is held with its front surface facing upwardly by the spindles 32 of the substrate holder 34. At this time, the upper roll cleaning member 40 lies at the standby position above the edge of the substrate W. While rotating the substrate W horizontally, the arm movement mechanism 44 is actuated to move the moving arm 48 at a predetermined speed so that the upper roll cleaning member 40 in the standby position moves toward the scrub cleaning position. The movement speed of the moving arm 48 is, for example, 30 mm/s.

Simultaneously with the start of movement of the moving arm 48, the carrier gas, such as N₂ gas, and the cleaning liquid, such as pure water, or water containing dissolved CO₂ gas, supplied into the two-fluid nozzle 70a comprised of a sector nozzle, begin to be jetted from the two-fluid nozzle 70a toward the front surface of the rotating substrate W to clean the surface of the substrate W with the two-fluid jet flow. After the jetting of the mixed fluid from the two-fluid nozzle 70a is continued for a predetermined time (e.g., 5 seconds), the jetting of the fluid from the two-fluid nozzle 70a is stopped. The upper roll cleaning member 40 is kept apart from the surface of the substrate W during the two-fluid jet cleaning.

Next, the upper roll cleaning member 40 is rotated and lowered to bring it into contact with the front surface of the rotating substrate W and, at the same time, a cleaning liquid is supplied from the upper cleaning liquid supply nozzle 60 to the front surface of the substrate W, thereby scrub cleaning of the front surface of the substrate W with the upper roll cleaning member 40 is carried out.

After carrying out the scrub cleaning of the front surface of the substrate W for a predetermined time, the upper roll cleaning member 40 is raised, and the supply of the cleaning liquid from the upper cleaning liquid supply nozzle 60 to the front surface of the substrate W is stopped. Next, the arm movement mechanism 54 is reversely operated to return the upper roll cleaning member 40 to the standby position. When returning the upper roll cleaning member 40 to the standby position, the mixed fluid may be jetted from the two-fluid nozzle 70a toward the front surface of the substrate W to perform two-fluid jet cleaning of the substrate.

In synchronization with the upper roll cleaning member 40, the lower roll cleaning member 50 is moved to the scrub cleaning position below the center of the substrate W. The lower roll cleaning member 50 is then rotated and raised to bring it into contact with the back surface of the rotating substrate W and, at the same time, a cleaning liquid is supplied from the lower cleaning liquid supply nozzle 62 to the back surface of the substrate W, thereby scrub cleaning of the back surface of the substrate W with the lower roll cleaning member 50 is carried out. After carrying out the scrub cleaning of the back surface of the substrate W for a predetermined time, the lower roll cleaning member 50 is lowered, and the supply of the cleaning liquid from the lower cleaning liquid supply nozzle 62 to the back surface of the substrate W is stopped. The lower roll cleaning member 50 is then returned to the standby position.

After scrub cleaning of the front and back surfaces of the substrate W is completed and the upper and lower roll cleaning members 40, 50 are returned to the respective standby positions in the above-described manner, the rotation of the substrate W is stopped and the substrate W is released from the holding by the substrate holder 34. The substrate W after cleaning is transferred to the next process.

Also in this embodiment, the upper roll cleaning member (scrub cleaning member) 40 is moved from the standby position above the edge of the substrate W to the scrub cleaning position above the center of the substrate W while carrying out two-fluid jet cleaning of the surface of the substrate W, and subsequently scrub cleaning of the surface of the substrate W is carried out. This makes it possible to successively carry out two-fluid jet cleaning and the immediately-following scrub cleaning of the surface of the substrate W without a significant increase in the cleaning time and to enhance the cleaning performance.

A series of tests (Ref. Example, Examples 1 to 3, and Comp. Examples 1 and 2) was conducted to determine the effects of two-fluid jet cleaning of a surface of a substrate after polishing, to be carried out prior to roll scrub cleaning, e.g., with a roll cleaning member. In each test, a surface of a TEOS blanket wafer (substrate) was polished for 60 seconds, and the surface of the substrate after polishing was cleaned and dried under the below-described conditions. For each substrate after drying, the number of particles (defects) having a diameter of not less than 100 nm, remaining on the surface of the substrate, was measured. The results are shown in Table 1 below.

TABLE 1

| | | | | | Comp. | Comp. |
|---|---|---|---|---|---|---|
| | Ref. | Example | Example | Example | Example | Example |
| | Example | 1 | 2 | 3 | 1 | 2 |
| Number | 1 | 1/30 | 1/9 | 1/5 | 1/1.6 | 1 |
| of | | | | | | |
| Particles | | | | | | |
| (100 nm) | | | | | | |

In Table 1, the number of particles in Reference Example is expressed as “1” which shows the number of the particles remaining on the surface of the substrate which has been subjected to SRD (spin-rinse-dry) process after polishing the surface of the substrate for 60 seconds. The number of particles in each of other examples is expressed in terms of the ratio to the number of particles measured in Reference Example. Polishing the surface of the substrate in each of examples was performed for 60 seconds.

In Example 1, while rotating the substrate at 600 rpm, two-fluid jet cleaning of the surface of the substrate, after polishing the surface of the substrate for 60 seconds, was carried out for 22 seconds, followed by SRD drying. In Example 2, while rotating the substrate at 600 rpm, two-fluid jet cleaning of the surface of the substrate after polishing was carried out for 5 seconds, followed by SRD drying. In Example 3, while rotating the substrate at 150 rpm, two-fluid jet cleaning of the surface of the substrate after polishing was carried out for 5 seconds, followed by SRD drying.

In Examples 1 to 3, a carrier gas at a flow rate of 100 L/min and carbonated water, which is to form liquid droplets, at a flow rate of 200 mL/min were supplied to a two-fluid nozzle having an inside diameter of 3 mm, during the two-fluid jet cleaning. The distance between the jet orifice of the two-fluid nozzle and the surface of the substrate was set at 8 mm.

In Comparative Example 1, while rotating the substrate at 150 rpm, megasonic cleaning of the surface of the substrate after polishing was carried out for 22 seconds, followed by SRD drying. In Comparative Example 2, while rotating the substrate at 150 rpm, megasonic cleaning of the surface of the substrate after polishing was carried out for 5 seconds, followed by SRD drying.

In Comparative Examples 1 and 2, the megasonic cleaning was carried out by supplying cleaning water, to which ultrasonic waves having a vibration frequency of 400 KHz was applied at an input power of 30 W, to the surface of the substrate at a flow rate of 3 L/min.

The data in Table 1 demonstrates that the number of particles remaining on the surface of the substrate after polishing can be reduced to ⅕- 1/30 by carrying out non-contact two-fluid jet cleaning of the surface of the substrate immediately after polishing, and that cleaning of the surface of the substrate by two-fluid jet cleaning produces a significantly higher particle removal effect compared to cleaning of the surface of the substrate by megasonic cleaning, another non-contact cleaning method. The experimental data thus indicates that the burden on scrub cleaning of a surface of a substrate after polishing can be significantly reduced by carrying out non-contact two-fluid jet cleaning of the surface of the substrate prior to the scrub cleaning.

While the present invention has been described with reference to preferred embodiments, it is understood that the present invention is not limited to the embodiments described above, but is capable of various changes and modifications within the scope of the inventive concept as expressed herein.

What is claimed is:

1. A substrate cleaning method comprising:
carrying out two-fluid jet cleaning of a surface of a substrate after polishing by jetting a mixed fluid, consisting of two or more types of fluids, from a two-fluid nozzle toward the surface of the substrate to clean the substrate in a non-contact manner, immediately before carrying out scrub cleaning of the substrate by rubbing a scrub cleaning member against the surface of the substrate.

2. The substrate cleaning method according to claim 1, wherein
a moving arm is moved to move a scrub cleaning member from a standby position above the edge of the substrate to a scrub cleaning position above the center of the substrate;
the two-fluid nozzle is moved in conjunction with the movement of the moving arm while jetting the fluid from the two-fluid nozzle toward the surface of the rotating substrate to carry out two-fluid jet cleaning of the substrate; and
after stopping the jetting of the fluid from the two-fluid nozzle, the scrub cleaning member is brought into contact with the surface of the substrate to carry out scrub cleaning of the substrate.

3. The substrate cleaning method according to claim 2, wherein the movement speed of the moving arm is changed during the two-fluid jet cleaning.

4. The substrate cleaning method according to claim 2, wherein the travel distance of the two-fluid nozzle that moves while jetting the fluid is shorter than the radius of the substrate.

5. The substrate cleaning method according to claim 1, wherein
while carrying out two-fluid jet cleaning of the surface of the substrate by jetting the fluid from the two-fluid nozzle, disposed above one edge position on the substrate, toward the surface of the rotating substrate, the scrub cleaning member is moved from a standby position above another edge position on the substrate to a scrub cleaning position above the center of the substrate; and
after stopping the jetting of the fluid from the two-fluid nozzle, the scrub cleaning member is brought into contact with the surface of the substrate to carry out scrub cleaning of the substrate.

6. The substrate cleaning method according to claim 5, wherein the two-fluid nozzle is a sector nozzle having a sector-shaped jet orifice.

7. A substrate cleaning apparatus comprising:
a substrate holder for holding and rotating a substrate;
a scrub cleaning member for rubbing it against a surface of the rotating substrate, held by the substrate holder, to carry out scrub cleaning of the substrate;
a two-fluid nozzle for jetting a mixed fluid, consisting of two or more types of fluids, toward the surface of the rotating substrate, held by the substrate holder, to carry out non-contact two-fluid jet cleaning of the substrate;
a moving arm for simultaneously moving the scrub cleaning member and the two-fluid nozzle; and
an arm movement mechanism for moving the moving arm so that the scrub cleaning member moves between a standby position above the edge of the substrate held by the substrate holder and a scrub cleaning position above the center of the substrate.

8. The substrate cleaning apparatus according to claim 7, wherein the two-fluid nozzle is mounted to the moving arm via a nozzle movement mechanism so that the two-fluid nozzle can move between a fluid jetting position where the two-fluid nozzle jets the fluid toward the surface of the rotating substrate and a standby position where the two-fluid nozzle does not interfere with contact of the scrub cleaning member with the surface of the substrate.

9. The substrate cleaning apparatus according to claim 7, wherein the arm movement mechanism can change the movement speed of the moving arm.

10. A substrate cleaning apparatus comprising:
a substrate holder for holding and rotating a substrate;
a scrub cleaning member for rubbing it against a surface of the rotating substrate, held by the substrate holder, to carry out scrub cleaning of the substrate;
a two-fluid nozzle, installed above one edge position on the substrate held by the substrate holder, for jetting a mixed fluid, consisting of two or more types of fluids, toward the surface of the rotating substrate, held by the substrate holder, to carry out non-contact two-fluid jet cleaning of the substrate;
a moving arm for moving the scrub cleaning member; and
an arm movement mechanism for moving the moving arm so that the scrub cleaning member moves between a standby position above another edge position on the substrate held by the substrate holder and a scrub cleaning position above the center of the substrate.

11. The substrate cleaning apparatus according to claim 10, wherein the two-fluid nozzle is a sector nozzle having a sector-shaped jet orifice.
